(19) United States
(12) Patent Application Publication
(10) Pub. No.: US 2010/0297407 A1
(43) Pub. Date: Nov. 25, 2010

(54) PLASTIC HOUSING AND MANUFACTURING METHOD THEREOF

(75) Inventors: QIN-ZHENG HOU, Shenzhen City (CN); YAN-MIN WANG, Shenzhen City (CN); GANG HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/693,638

(22) Filed: Jan. 26, 2010

(30) Foreign Application Priority Data
May 23, 2009 (CN) 200910302552.7

(51) Int. Cl. B32B 15/08; C08F 2/48

(52) U.S. Cl. 428/203; 427/509

(57) ABSTRACT

A plastic housing comprises a transparent exterior coating, a metallic coating and a substrate. The exterior coating has a first surface and a second surface. A partial of the first surface of the exterior coating is defined a plurality of groove groups thereon. The metallic coating is formed on the second surface of the exterior coating. The substrate is bonded with the metallic coating. A method for making the plastic housing is also described there.

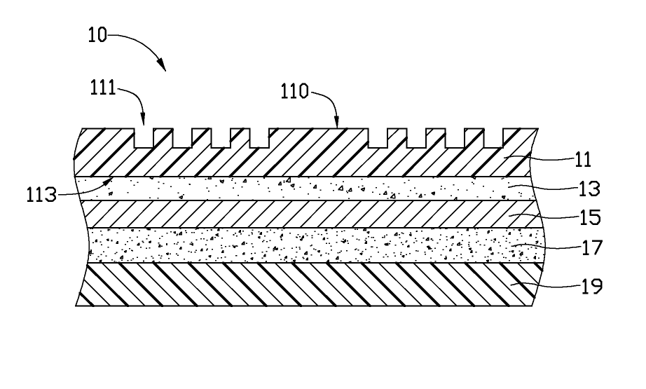

### BACKGROUND

1. Technical Field

The present disclosure relates to plastic housings, especially to a plastic housing having a decorative metallic appearance, and a manufacturing method thereof.

2. Description of Related Art

Housings of portable electronic devices are commonly made of plastic. These plastic housings are usually coated with paint to form a protective coating. The paint coatings commonly present a single and dull color, which hardly improves the appearance of the housing. A housing having an appearance of metal that is drill-carved will be more attractive.

Therefore, there is room for improvement within the art.

### BRIEF DESCRIPTION OF THE FIGURE

Many aspects of the plastic housing can be better understood with reference to the following FIGURE. The components in the FIGURE are not necessarily drawn to scale, the emphasis instead being placed upon clearly illustrating the principles of the plastic housing.

The FIGURE is a cross-sectional view of an exemplary embodiment of a plastic housing.

### DETAILED DESCRIPTION

Referring to the FIGURE, in an exemplary embodiment, a plastic housing 10 includes an exterior coating 11, a decorative coating 13 bonded with the exterior coating 11, a metallic coating 15 bonded with the decorative coating 13, a protective coating 17 bonded with the metallic coating 15, and a substrate 19 bonded with the protective coating 17. The coatings 11-17 are applied sequentially to the interior of a mold and are then transferred to the substrate 19 in a molding process to form the plastic housing 10.

The exterior coating 11 may be a transparent plastic coating formed by molding. The exterior coating 11 has a first surface 110 and a second surface 113 opposite to the first surface 110. The mold has cavities with partial pre-defined grooved surface. Part of the region of the first surface 110 can be defined with a plurality of groove groups 111 developed during the molding process. These groove groups 111 may define a pattern resembling a rhombus, concentric circles, or other geometric shapes. Each groove of the groove groups 111 has a depth of about 10-30 μm. The exterior coating 11 may have a thickness of about 0.175-0.2 mm. The plastic for molding the exterior coating 11 can be selected from a group consisting of polypropylene (PP), polyamide (PA), polycarbonate (PC), polymethyl methacrylate (PMMA), and polyethylene terephthalate (PET).

The decorative coating 13 may be a transparent or translucent ink coating formed by printing. The decorative coating 13 is bonded to the second surface 113 of the exterior coating 11.

The metallic coating 15 is formed on the exposed surface of the decorative coating 13 by vacuum deposition. The metallic coating 15 has a metallic appearance. The material used for the metallic coating 15 can be a metal or a nonmetal having a metallic appearance. The metal may be indium, tin, indium-tin alloy, aluminum, titanium, chromium, stainless steel, vanadium or gold. The nonmetal may be titanium carbide, titanium nitride, titanium oxide or alumina. The metallic coating 15 can be nonconductive by choosing the above-mentioned materials and by controlling the thickness of the metallic coating 15 to a range of about 0.01-10 μm.

The protective coating 17 may be an ultraviolet (UV) curing paint coating formed on the exposed surface of the metallic coating 15 by printing.

The substrate 19 may be a plastic coating molded on the exposed surface of the protective coating 17. The material of molding the substrate 19 can be selected from a group consisting of polyethylene (PE), polycarbonate (PC), acrylonitrile-butadiene-styrene (ABS), polymethyl methacrylate (PMMA), and polyethylene terephthalate (PET).

The exemplary transparent exterior coating 11 has a first surface 110 having partially formed with a plurality of groove groups 111 and a second surface 113 bonded with a metallic coating 15 or a transparent decorative coating 13 and a metallic coating 15, which makes the plastic housing 10 have an attractive appearance.

A method for making the plastic housing 10 may comprise the following steps: molding a transparent exterior coating having a first surface and a second surface, a partial region of the first surface defining a plurality of groove groups during the molding of the exterior coating; vacuum depositing a metallic coating on the second surface of the exterior coating; and molding a substrate on the metallic coating.

An exterior coating 11 is molded in a mold. The exterior coating 11 has a first surface 110 and a second surface 113 opposite to the first surface 110. The mold has a cavity with a pre-defined grooved surface bounding a portion thereof, accordingly, a portion of the first surface 110 will be formed with a corresponding plurality of groove groups 111 thereon during the molding process. These groove groups 111 may define patterns as disclosed above.

A decorative coating 13 is applied on the second surface 113 of the exterior coating 11. The decorative coating 13 may be a transparent or translucent ink coating formed by printing.

A metallic coating 15 is applied on the exposed surface of the decorative coating 13 by vacuum deposition. The material used for the metallic coating 15 can be a metal or a nonmetal having a metallic appearance. The metal may be indium, tin, indium-tin alloy, aluminum, titanium, chromium, stainless steel, vanadium or gold. The nonmetal may be titanium carbide, titanium nitride, titanium oxide or alumina.

A protective coating 17 is applied on the exposed surface of the metallic coating 15. The protective coating 17 may be an UV paint coating formed by printing. The UV paint can be repeatedly printed, 5-7 times for example, to increase the thickness and the protection of the protective coating 17.

The coatings 11-17 are then applied to the interior of a mold and the substrate 19 is molded onto the protective coating 17 to form the plastic housing 10.

It should be understood, the decorative coating 13 is not necessary. The metallic coating 15 can be directly formed on the second surface 113 of the exterior coating 11.

It should be understood, the protective coating 17 is also not necessary. The substrate 19 can be directly molded on the metallic coating 15.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A plastic housing, comprising:
a transparent exterior coating, the exterior coating having a first surface and a second surface, part of the first surface defining a plurality of groove groups thereon;
a metallic coating formed on the second surface of the exterior coating; and
a substrate bonded with the metallic coating.

2. The plastic housing as claimed in claim 1, wherein the exterior coating has a thickness of about 0.175-0.2 mm.

3. The plastic housing as claimed in claim 1, wherein each groove of the groove groups has a depth of about 10-30 μm.

4. The plastic housing as claimed in claim 1, wherein the plastic coating further includes a decorative coating, the decorative coating is formed between the second surface of the exterior coating and the metallic coating.

5. The plastic housing as claimed in claim 4, wherein the decorative coating is a transparent or translucent ink coating.

6. The plastic housing as claimed in claim 4, wherein the plastic housing further includes a protective coating, the protective coating is disposed between the metallic coating and the substrate.

7. The plastic housing as claimed in claim 6, wherein the protective coating is an ultraviolet curing paint coating.

8. The plastic housing as claimed in claim 1, wherein the metallic coating contains material selected from a group consisting of indium, tin, indium-tin alloy, aluminum, titanium, chromium, stainless steel, vanadium and gold or a group consisting of titanium carbide, titanium nitride, titanium oxide and alumina.

9. The plastic housing as claimed in claim 1, wherein the metallic coating is formed by vacuum deposition.

10. A method for making plastic housing, comprising:
molding a transparent exterior coating having a first surface and a second surface, a partial region of the first surface defining a plurality of groove groups thereon during the molding of the exterior coating;
vacuum depositing a metallic coating on the second surface of the exterior coating; and
molding a substrate on the metallic coating.

11. The method as claimed in claim 10, wherein the method further includes a step of printing a decorative coating on the second surface of the exterior coating before forming the metallic coating.

12. The method as claimed in claim 11, wherein the decorative coating is a transparent or translucent ink coating.

13. The method as claimed in claim 10, wherein the method further includes a step of printing a protective coating on the metallic coating before molding the substrate.

14. The method as claimed in claim 13, wherein the protective coating is an ultraviolet curing paint coating.
